(19) United States
(12) Patent Application Publication
(10) Pub. No.: US 2012/0027511 A1
(43) Pub. Date: Feb. 2, 2012

(54) FASTENING DEVICE AND OBJECT HAVING THE SAME

(76) Inventors: Ren-Jing WEI, New Taipei City (TW); Cheng-Hsiang Chuang, New Taipei City (TW)

(21) Appl. No.: 13/052,233

(22) Filed: Mar. 21, 2011

(30) Foreign Application Priority Data
Jul. 28, 2010 (TW) 099124902

(51) Int. Cl. F16B 17/00

(52) U.S. Cl. 403/381

(57) ABSTRACT

A fastening device includes first and second hooks, a stopper member, and two fixed plates. The first hook is disposed on the first article, and has a first hook portion. The stopper member is disposed on the first article, and is spaced apart from the first hook in a left-to-right direction. The fixed plates are disposed on the second article, and are spaced apart from each other in a front-to-rear direction. Each fixed plate has a pivot groove and a first positioning portion. The second hook is connected pivotally between the fixed plates, and extends between the first hook portion and the stopper member. The second hook has a second hook portion engaging removably the first hook portion, two pivot shafts, and two second positioning portions. The pivot shafts are rotatable respectively within the pivot grooves. Each second positioning portion engages the corresponding first positioning portion.

### CROSS-REFERENCE TO RELATED APPLICATION

This application claims priority of Taiwanese Application No. 099124902, filed on Jul. 28, 2010.

### BACKGROUND OF THE INVENTION

1. Field of the Invention

This invention relates to a fastening device and an object having the same, and more particularly to a non-threaded fastening device and an object having the same, the fastening device being convenient to assemble and disassemble quickly.

2. Description of the Related Art

Referring to FIGS. 1 and 2, a fastening device 1 disclosed in Taiwanese Patent No. M288756 (Application No. 094216081) is used to interconnect a first housing 21 and a second housing 22. The fastening device 1 includes two retaining hooks 11 disposed on the first housing 21 and spaced apart from each other in a left-to-right direction, and two retaining members 12 disposed on the second housing 22 and spaced apart from each other in the left-to-right direction. Each of the retaining hooks 11 has an arm 111 connected to the first housing 21, and a hook portion 112 disposed on a bottom end of the arm 111. The hook portions 111 extend respectively from the arms 111 in opposite directions. Each of the retaining members 12 has a retaining groove 121 engageable with the hook portion 112 of the corresponding retaining hook 11.

When it is desired to fasten the first housing 21 to the second housing 22, the retaining hooks 11 are pressed respectively toward the retaining members 12. When downwardly facing inclined surfaces 113 of the hook portions 112 come into contact with upwardly facing inclined surfaces 122 of the retaining members 12, the hook portions 112 and, thus, the arms 111 are pushed outwardly to thereby deform the arms 111. As soon as the hook portions 112 are aligned respectively with the retaining grooves 121, the former are biased into the latter due to the returning force of the deformed arms 111. Hence, the hook portions 112 abut respectively against stop walls 123 to thereby prevent removal of the first housing 21 from the second housing 22.

Since the arms 111 of the retaining hooks 11 are connected fixedly to the first housing 21, if a force is applied improperly to either of the retaining hooks 11 during assembly or disassembly of the fastening device 1, breakage may occur at the junction between the first housing 21 and the corresponding arm 111. Therefore, it is desirable to assemble and disassemble the fastening device quickly, in such a manner to prevent breakage of the fastening device.

### SUMMARY OF THE INVENTION

An object of this invention is to provide a fastening device that is convenient to interconnect two articles quickly and that can be prevented from breakage during operation.

Another object of this invention is to provide an object that includes a fastening device, which is convenient to interconnect two articles quickly and which can be prevented from breakage during operation.

According to an aspect of this invention, there is provided a fastening device adapted to fasten a first article to a second article, the second article being disposed on and above the first article, the fastening device comprising:

a first hook adapted to be disposed on the first article and having a first hook portion disposed at a top end thereof;

a stopper member adapted to be disposed on the first article and spaced apart from the first hook in a left-to-right direction, the stopper member having a stop surface facing the first hook portion;

two fixed plates adapted to be disposed on the second article and spaced apart from each other in a front-to-rear direction, each of the fixed plates having a pivot groove, and a first positioning portion spaced apart from and disposed under the pivot groove; and

a second hook connected pivotally between the fixed plates and extending between the first hook portion and the stop surface of the stopper member, the second hook having a second hook portion disposed at a bottom end thereof and engaging removably the first hook portion, two pivot shafts disposed respectively at two opposite sides thereof, and two second positioning portions disposed respectively at the two opposite sides thereof, one of the first and second hook portions having a first guiding inclined surface that faces upwardly, and a second guiding inclined surface that faces downwardly, the other of the first and second hook portions being contactable with one of the first and second guiding inclined surfaces, the pivot shafts being disposed respectively and rotatably within the pivot grooves, each of the second positioning portions being spaced apart from a corresponding one of the pivot shafts and engaging a corresponding one of the first positioning portions.

According to another aspect of this invention, there is provided an object comprising:

a first article;

a second article disposed on and above said first article; and

a fastening device including
a first hook disposed on the first article and having a first hook portion disposed at a top end thereof,
a stopper member disposed on the first article and spaced apart from the first hook in a left-to-right direction, the stopper member having a stop surface facing the first hook portion,
two fixed plates disposed on the second article and spaced apart from each other in a front-to-rear direction, each of the fixed plates having a pivot groove, and a first positioning portion spaced apart from and disposed under the pivot groove, and
a second hook connected pivotally between the fixed plates and extending between the first hook portion and the stop surface of the stopper member, the second hook having a second hook portion disposed at a bottom end thereof and engaging removably the first hook portion, two pivot shafts disposed respectively at two opposite sides thereof, and two second positioning portions disposed respectively at the two opposite sides thereof, one of the first and second hook portions having a first guiding inclined surface that faces upwardly, and a second guiding inclined surface that faces downwardly, the other of the first and second hook portions being contactable with one of the first and second guiding inclined surfaces, the pivot shafts being disposed respectively and rotatably within the pivot grooves, each of the second positioning portions being spaced apart from a corresponding one of the pivot shafts and engaging a corresponding one of the first positioning portions.

As such, the second article can be quickly assembled to and disassembled from the first article, thereby resulting in convenience during use of the object. Furthermore, when an excessive force is applied to separate the second article from the first article, the second positioning portions are removed respectively from the first positioning portions to allow for rotation of the second hook about the pivot shafts to thereby prevent breakage of the second hook.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is an exploded perspective view of a conventional fastening device disclosed in Taiwanese Patent No. M288756;

FIG. 2 is an assembled perspective view of the conventional fastening device;

FIG. 3 is a partly exploded perspective view of the preferred embodiment of an object according to this invention;

FIG. 4 is a fragmentary, partly exploded perspective view of the preferred embodiment, illustrating that a second hook is removed from two fixed plates;

FIG. 5 is a fragmentary, partly exploded perspective view of the preferred embodiment, illustrating modifications to first and second positioning portions;

FIG. 6 is a fragmentary schematic view of the preferred embodiment, illustrating that a first hook portion is pushed outwardly by a second hook portion during assembly of first and second articles;

FIG. 7 is a fragmentary schematic side view of the preferred embodiment, illustrating that the second hook portion is confined between the first hook portion and a stopper member;

FIG. 8 is a fragmentary perspective view of the preferred embodiment, illustrating that the second hook portion is confined between the first hook portion and the stopper member;

FIG. 9 is a fragmentary schematic side view of the preferred embodiment, illustrating that the first hook portion is pushed outwardly by the second hook portion during separation of the first and second articles;

FIG. 10 is a fragmentary schematic side view of the preferred embodiment, illustrating that movement of the second hook portion in a first or second direction results in separation of the first and second positioning portions and clockwise rotation of the second hook; and

FIG. 11 is a fragmentary schematic side view of the preferred embodiment, illustrating that movement of the second hook portion in a third direction results in separation of the first and second positioning portions and counterclockwise rotation of the second hook.

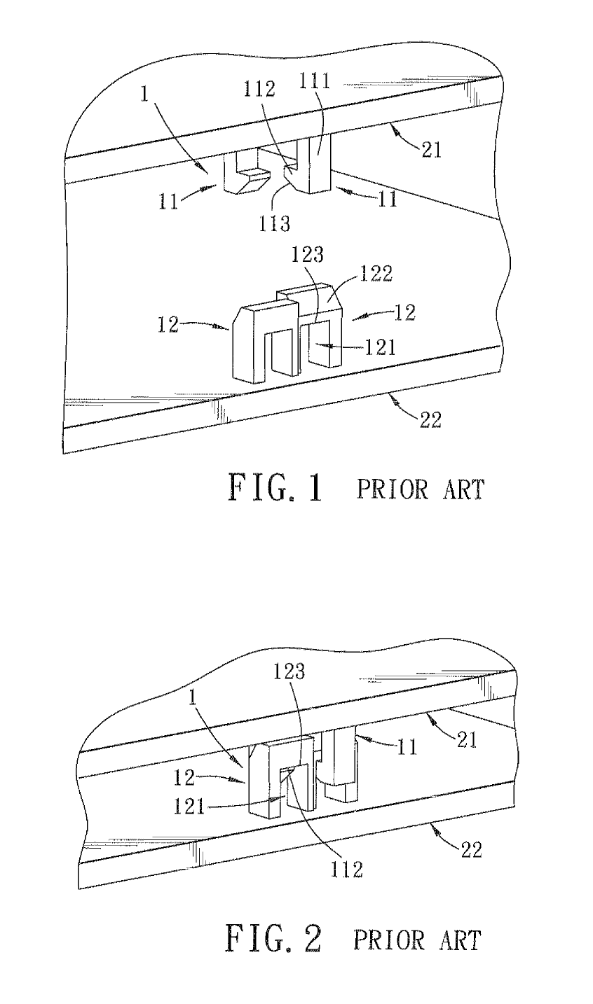

### DETAILED DESCRIPTION OF THE PREFERRED EMBODIMENT

Before the present invention is described in greater detail in connection with the preferred embodiments, it should be noted that similar elements and structures are designated by like reference numerals throughout the entire disclosure.

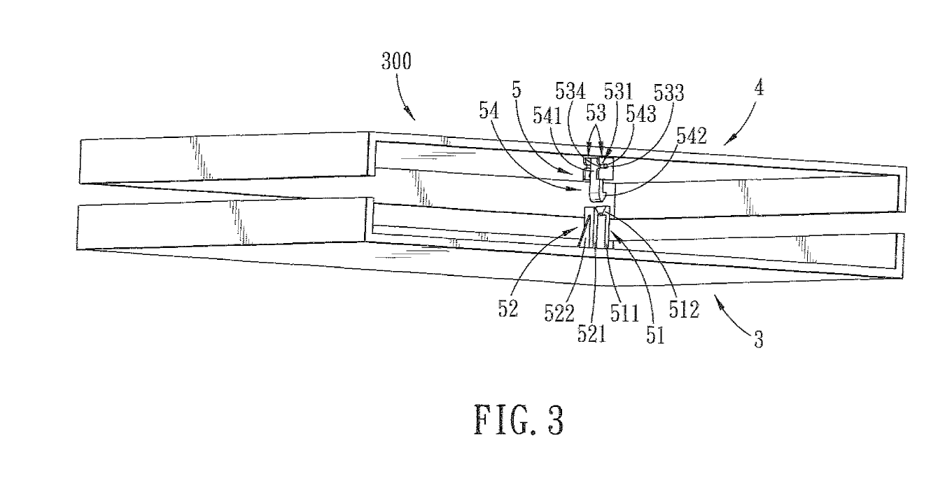

Referring to FIG. 3, the preferred embodiment of an object 300 according to this invention includes a first article 3, a second article 4, and a fastening device 5 for fastening the first and second articles 3, 4 to each other. In this embodiment, the object 300 is exemplified using a mainframe housing of a notebook computer. The first article 3 is an upper housing portion. The second article 4 is a lower housing portion. Alternatively, the object 300 may be a housing of a planet computer, a personal digital assistant, or a mobile phone, or any other similar product having two articles that are interconnected removably.

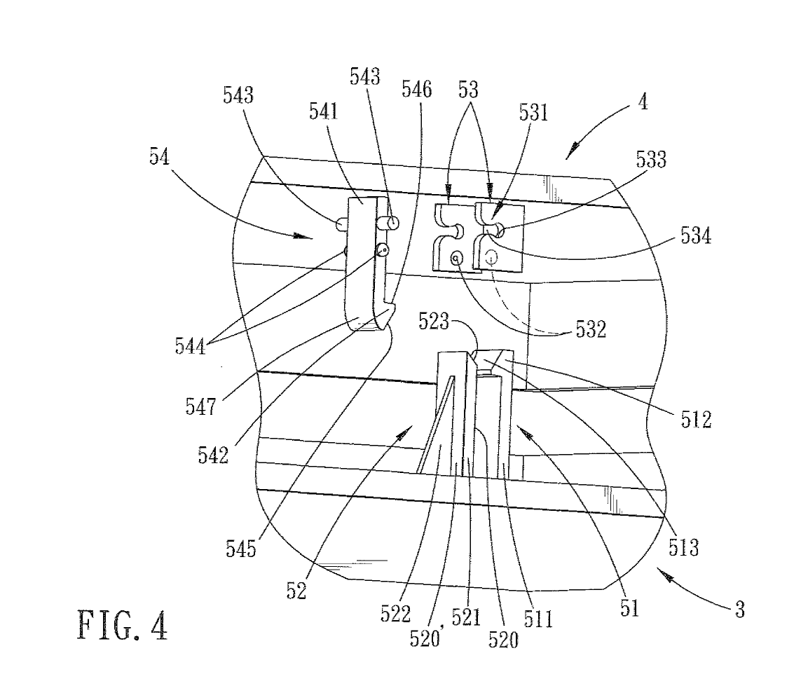

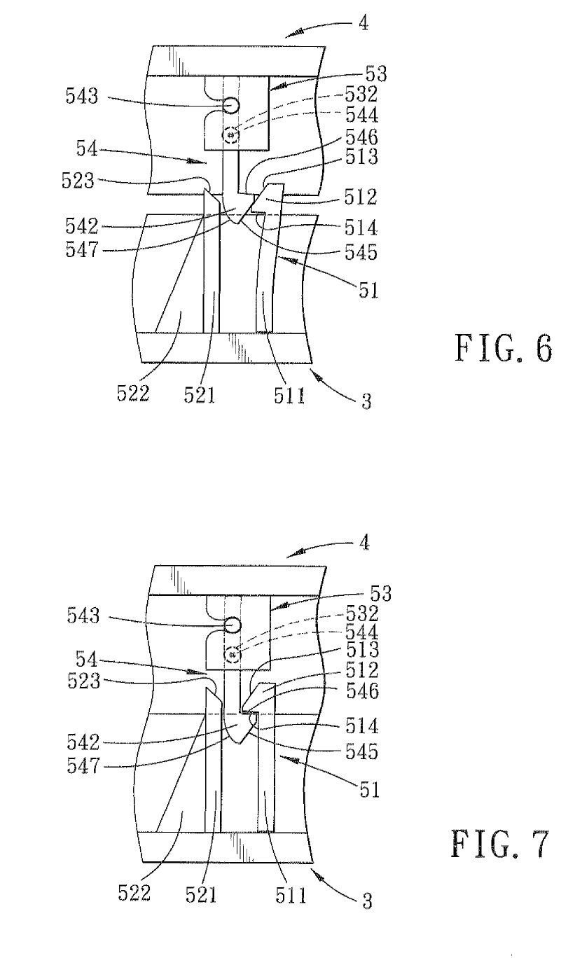

With further reference to FIG. 4, the fastening device 5 includes a first hook 51, a stopper member 52, two fixed plates 53, and a second hook 54. The first hook 51 is disposed on the first article 3, and has a first hook portion 512. The stopper member 52 is disposed on the first article 3, is spaced apart from the first hook 51 in a left-to-right direction, and has a stop surface 520 facing the first hook portion 512. The fixed plates 53 are disposed on the second article 4, and are spaced apart from each other in a front-to-rear direction. Each of the fixed plates 53 has a pivot groove 531, and a first positioning portion 532 disposed under the pivot groove 531. The second hook 54 is connected pivotally between the fixed plates 53, and extends between the first hook portion 512 and the stopper member 52. The second hook 54 has a second hook portion 542 disposed at a bottom end thereof and engaging removably the first hook portion 512, two pivot shafts 543 disposed respectively at two opposite sides thereof, and two second positioning portions 544 disposed respectively at the two opposite sides thereof. The first hook portion 512 has a first guiding inclined surface 513 that faces upwardly, and a second guiding inclined surface 514 (see FIG. 6) that faces downwardly. The second hook portion 542 is movable to contact the first or second guiding inclined surface 513, 514. The pivot shafts 543 are disposed respectively and rotatably within the pivot grooves 531. Each of the second positioning portions 544 is spaced apart from and disposed under the corresponding pivot shaft 543, and engages the corresponding first positioning portion 532. As such, the second article 4 can be assembled to and disassembled from the first article 3 conveniently and quickly.

The detailed structures of the components as well as assembly and disassembly thereof will be described. The first hook 51 further has an arm portion 511 connected integrally to the first article 3. The first hook portion 512 is disposed at a top end of the arm portion 511. The second hook 54 further has an arm portion 541. The second hook portion 542 is disposed at a bottom end of the arm portion 541. The stopper member 52 further has a stop block 521 connected integrally to the first article 3. The stop block 521 has the stop surface 520. The distance between the stop block 521 and the first hook portion 512 is slightly greater than the width of the arm portion 541 of the second hook 54 so as to allow for extension of the arm portion 541 of the second hook 54 between the stop block 521 and the first hook portion 512. The distance between the stop block 521 and the first hook portion 512 is smaller than the width of the second hook portion 542 so as to confine the second hook portion 542 between the first hook 51 and the stop block 521.

In this embodiment, the first hook 51 is made of a plastic material such that, when the first hook portion 512 is pushed by the second hook portion 542 of the second hook 54, that arm portion 511 of the first hook 51 deforms to have a returning force. The stopper member 52 is also connected integrally to the first article 3, as described above, so that the stop block 521 is deformed easily. To diminish the deformation of the stop block 521, the stopper member 52 further has an upright reinforcing plate 522 connected between the first article 3 and an outer side surface 520′ of the stop block 521 opposite to the stop surface 520.

Each of the fixed plates 53 is connected integrally to the second article 4. The pivot shafts 543 extend respectively from front and rear sides of the arm portion 541. Since the pivot shafts 543 are disposed respectively and rotatably within the pivot grooves 531, as described above, the second hook 54 is rotatable about the pivot shafts 543 between the fixed plates 53. In this embodiment, each of the pivot grooves 531 has a curved engaging groove portion 533 that receives rotatably the corresponding pivot shaft 543, and a guiding groove portion 534 that is open in the left-to-right direction and that guides movement of the corresponding pivot shaft 543 into the engaging groove portion 533. As such, the second hook 54 can be assembled quickly to the fixed plates 53.

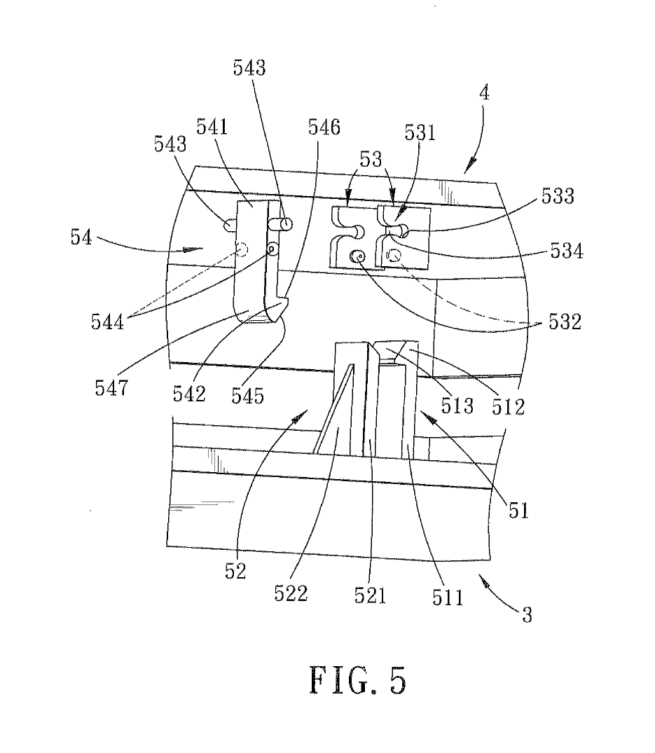

In this embodiment, each of the first positioning portions 532 is a circular groove, and each of the second positioning portions 544 is a cylindrical tongue engaging removably the corresponding circular groove. Since the first positioning portions 532 engage respectively the second positioning portions 544, the arm portion 541 of the second hook 54 is held at a vertical position, and rotation of the second hook 54 about the pivot shafts 543 is prevented. In an alternative arrangement shown in FIG. 5, each of the first positioning portions 532 is a cylindrical tongue, and each of the second positioning portions 544 is a circular groove.

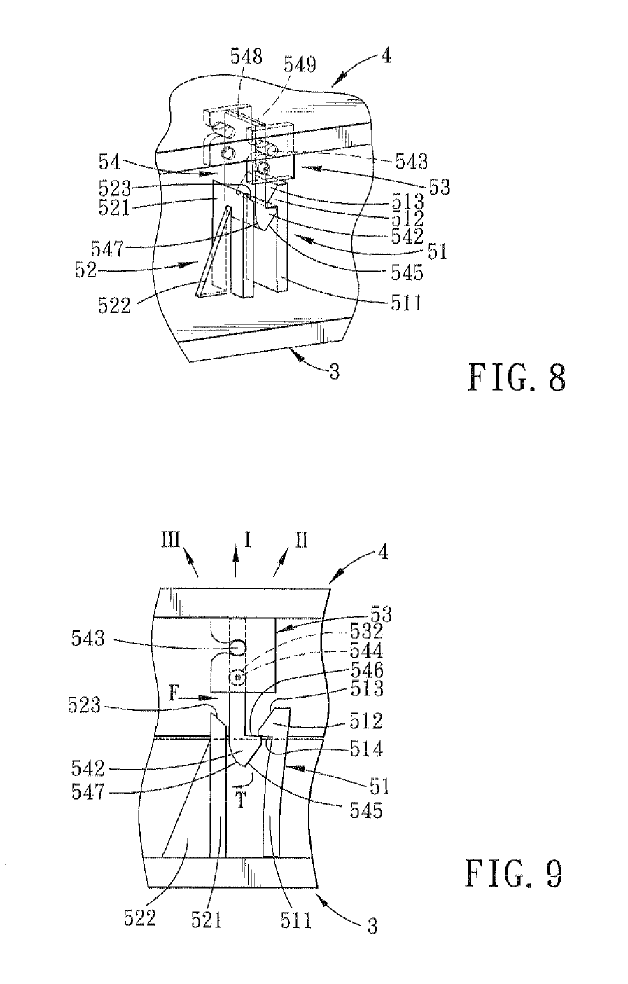

Referring to FIGS. 6, 7, and 8, when it is desired to fasten the second article 4 to the first article 3, the second article 4 is moved relative to the first article 3 to align the second hook 54 with the space between the first hook 51 and the stop block 521 of the stopper member 52. Subsequently, the second article 4 is moved toward the first article 3, so that a first contact inclined surface 545 of the second hook portion 542 comes into contact with the first guiding inclined surface 513. Hence, a horizontal force component is applied to the first guiding inclined surface 513 to push the first hook portion 512 outwardly to thereby deform the arm portion 511 of the first hook 51. As soon as the second hook portion 542 moves downwardly past the first hook portion 512, the second article 4 comes into contact with the first article 3 to thereby prevent further downward movement of the second hook portion 542 relative to the first hook portion 512, and the first hook portion 512 is biased to its original position due to the returning force of the arm portion 511. Hence, the second guiding inclined surface 514 of the first hook portion 512 abuts against a second contact inclined surface 546 of the second hook portion 542, as shown in FIG. 7. At this time, the fastening device 5 is in a locking state, and the second article 4 is fastened to the first article 3.

Preferably, the stopper member 52 further has a third guiding inclined surface 523 that faces upwardly and that is aligned with the first guiding inclined surface 513. The second hook portion 542 further has a contact curve surface 547 contactable with the third guiding inclined surface 523. During downward movement of the second hook 54, when the contact curve surface 547 comes into contact with the third guiding inclined surface 523, since the rigidity of the stop block 521 of the stopper member 52 is increased by the reinforcing plate 522, the stop block 521 cannot deform. As a consequence, the second hook portion 542 is guided by the third guiding inclined surface 523 to contact the first guiding inclined surface 513 of the first hook portion 512, so as to facilitate movement of the second hook portion 542 to a position under the first hook portion 512, thereby allowing for easy assembly of the fastening device 5.

Referring to FIGS. 7 and 9, during disassembly of the second article 4 from the first article 3, when the second article 4 is pulled upwardly in a first direction (I) or upwardly and rightwardly in a second direction (II), the second contact inclined surface 546 of the second hook portion 542 comes into contact with the second guiding inclined surface 514 of the first hook portion 512. At this time, a force component is applied to the second guiding inclined surface 514 by the second hook portion 542 to push the first hook portion 512 outwardly to thereby deform the arm portion 511. Upon contact of the second hook portion 542 with the first hook portion 512, a reaction force occurs so that a clockwise torque (T) is applied to the second hook portion 542. If the torque (T) is smaller than a torque value so that the first positioning portions 532 cannot be removed from the second positioning portions 544, the arm portion 541 of the second hook 54 will remain in the vertical position. Also during disassembly of the second article 4 from the first article 3, the second article 4 may be pulled upwardly and leftwardly in a third direction (III). When the arm portion 541 of the second hook 54 comes into contact with the stop block 521 of the stopper member 52, a reaction force occurs so that a lateral force (F) is applied to the arm portion 541. If the lateral force (F) is smaller than a force value so that the first positioning portions 532 cannot be removed from the second positioning portions 544, the arm portion 541 of the second hook 54 will remain in the vertical position. It should be noted that, the torque value and the force value are determined according to the sizes of the first and second positioning portions 532, 544.

When the second hook portion 542 moves upwardly past the first hook portion 512, the fastening device 5 is in a release state, and the second article 4 can be separated from the first article 3.

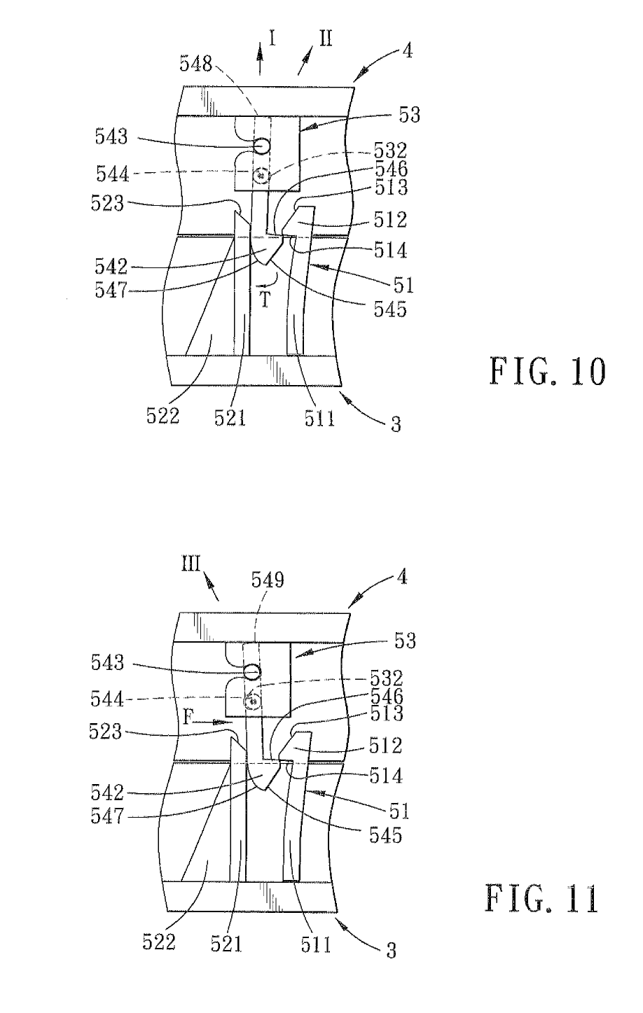

Referring to FIG. 10, when the second article 4 is moved in the first or second directions (I, II), if the clockwise torque (T) is greater than the torque value so that the first positioning portions 532 are separated from the second positioning portions 544, the second hook 54 will rotate clockwise about the pivot shafts 543 relative to the fixed plates 53. As such, breakage of the arm portion 541 of the second hook 54 resulting from excessive clockwise torque can be prevented. Since the second hook 54 further has a first stop inclined surface 548 disposed at a top end thereof and extending downwardly and leftwardly, as soon as the first stop inclined surface 548 rotates to contact a bottom surface of the second article 4, further clockwise rotation of the second hook 54 is prevented, thereby limiting the clockwise rotational angle of the second hook 54.

Referring to FIG. 11, when the second article 4 is moved in the third directions (III), if the lateral force (F) is greater than the force value so that the first positioning portions 532 is separated from the second positioning portions 544, the second hook 54 will rotate counterclockwise about the pivot shafts 543 relative to the fixed plates 53. As such, breakage of the arm portion 541 of the second hook 54 resulting from excessive lateral force can be prevented. Since the second hook 54 further has a second stop inclined surface 549 disposed at the top end thereof and extending downwardly and rightwardly, as soon as the second stop inclined surface 549 rotates to contact the bottom surface of the second article 4, further counterclockwise rotation of the second hook 54 is prevented, thereby limiting the counterclockwise rotational angle of the second hook 54.

In view of the above, due to the design of the fastening device 5, the second article 4 can be quickly assembled to and disassembled from the first article 3, thereby resulting in convenience during use of the object 300. Furthermore, since the pivot shafts 543 of the second hook 54 are disposed respectively and rotatably within the engaging groove portions 533 in the fixed plates 53, and since the second positioning portions 544 of the second hook 54 engage respectively and removably the first positioning portions 532 of the fixed plates 53, when the second hook 54 is subjected to an excessive torque or force, the second positioning portions 544 are separated respectively from the first positioning portions 532 to allow for rotation of the second hook 54 about the pivot shafts 543, thereby preventing the breakage of the second hook 54. Thus, the object of this invention is achieved.

With this invention thus explained, it is apparent that numerous modifications and variations can be made without departing from the scope and spirit of this invention. It is therefore intended that this invention be limited only as indicated by the appended claims.

I claim:

1. A fastening device adapted to fasten a first article to a second article, the second article being disposed on and above the first article, said fastening device comprising:
a first hook adapted to be disposed on the first article and having a first hook portion disposed at a top end thereof;
a stopper member adapted to be disposed on the first article and spaced apart from said first hook in a left-to-right direction, said stopper member having a stop surface facing said first hook portion;
two fixed plates adapted to be disposed on the second article and spaced apart from each other in a front-to-rear direction, each of said fixed plates having a pivot groove, and a first positioning portion spaced apart from and disposed under said pivot groove; and
a second hook connected pivotally between said fixed plates and extending between said first hook portion and said stop surface of said stopper member, said second hook having a second hook portion disposed at a bottom end thereof and engaging removably said first hook portion, two pivot shafts disposed respectively at two opposite sides thereof, and two second positioning portions disposed respectively at the two opposite sides thereof, one of said first and second hook portions having a first guiding inclined surface that faces upwardly, and a second guiding inclined surface that faces downwardly, the other of said first and second hook portions being contactable with one of said first and second guiding inclined surfaces, said pivot shafts being disposed respectively and rotatably within said pivot grooves, each of said second positioning portions being spaced apart from a corresponding one of said pivot shafts and engaging a corresponding one of said first positioning portions.

2. The fastening device as claimed in claim 1, wherein said second positioning portions are removable respectively from said first positioning portions to allow said second hook to rotate about said pivot shafts.

3. The fastening device as claimed in claim 2, wherein each of said first positioning portions is configured as one of a circular groove and a cylindrical tongue, and each of said second positioning portions is configured as the other of said circular groove and said cylindrical tongue.

4. The fastening device as claimed in claim 2, wherein said second hook further has a first stop inclined surface and a second stop inclined surface that are disposed at a top end thereof and that are adapted to be rotatable into contact with the second article for limiting rotational angles of said second hook relative to the second article in different directions.

5. The fastening device as claimed in claim 4, wherein the other of said first and second hook portions has a first contact inclined surface movable to contact said first guiding inclined surface, and a second contact inclined surface movable to contact said second guiding inclined surface.

6. The fastening device as claimed in claim 1, wherein said stopper member has a third guiding inclined surface facing upwardly and aligned with said first guiding inclined surface, said second hook portion further having a contact curve surface movable to contact said third guiding inclined surface.

7. The fastening device as claimed in claim 6, wherein said stopper member further has: a stop block, said stop surface being disposed at said stop block, said stop block further having an outer side surface opposite to said stop surface; and an upright reinforcing plate adapted to be connected between said outer side surface of said stop block and the first article.

8. The fastening device as claimed in claim 1, wherein said pivot groove in each of said fixed plates has an engaging groove portion receiving rotatably a corresponding one of said pivot shafts and disposed above and spaced apart from a corresponding one of said first positioning portions, and a guiding groove portion that is open in the left-to-right direction and that guides movement of the corresponding one of said pivot shafts into said engaging groove portion.

9. The fastening device as claimed in claim 1, wherein the other of said first and second hook portions has a first contact inclined surface movable to contact said first guiding inclined surface, and a second contact inclined surface movable to contact said second guiding inclined surface.

10. An object comprising:
a first article;
a second article disposed on and above said first article; and
a fastening device including
a first hook disposed on said first article and having a first hook portion disposed at a top end thereof,
a stopper member disposed on said first article and spaced apart from said first hook in a left-to-right direction, said stopper member having a stop surface facing said first hook portion,
two fixed plates disposed on said second article and spaced apart from each other in a front-to-rear direction, each of said fixed plates having a pivot groove, and a first positioning portion spaced apart from and disposed under said pivot groove, and
a second hook connected pivotally between said fixed plates and extending between said first hook portion and said stop surface of said stopper member, said second hook having a second hook portion disposed at a bottom end thereof and engaging removably said first hook portion, two pivot shafts disposed respectively at two opposite sides thereof, and two second positioning portions disposed respectively at the two opposite sides thereof, one of said first and second hook portions having a first guiding inclined surface that faces upwardly and a second guiding inclined surface that faces downwardly, the other of said first and second hook portions being contactable with one of said first and second guiding inclined surfaces, said pivot shafts being disposed respectively and rotatably within said pivot grooves, each of said second positioning portions being spaced apart from a corresponding one of said pivot shafts and engaging a corresponding one of said first positioning portions.

11. The object as claimed in claim 10, wherein said second positioning portions are removable respectively from said first positioning portions to allow said second hook to rotate about said pivot shafts.

12. The object as claimed in claim 11, wherein each of said first positioning portions is configured as one of a circular groove and a cylindrical tongue, and each of said second positioning portions is configured as the other of said circular groove and said cylindrical tongue.

13. The object as claimed in claim 11, wherein said second hook further has a first stop inclined surface and a second stop inclined surface that are disposed at a top end thereof and that are rotatable to contact said second article for limiting rotational angles of said second hook relative to said second article in different directions.

14. The object as claimed in claim 13, wherein the other of said first and second hook portions has a first contact inclined surface movable to contact said first guiding inclined surface, and a second contact inclined surface movable to contact said second guiding inclined surface.

15. The object as claimed in claim 10, wherein said stopper member has a third guiding inclined surface facing upwardly and aligned with said first guiding inclined surface, said second hook portion further having a contact curve surface movable to contact said third guiding inclined surface.

16. The object as claimed in claim 15, wherein said stopper member further has: a stop block, said stop surface being disposed at said stop block, said stop block further having an outer side surface opposite to said stop surface; and an upright reinforcing plate connected between said outer side surface of said stop block and said first article.

17. The object as claimed in claim 10, wherein said pivot groove in each of said fixed plates has an engaging groove portion receiving rotatably a corresponding one of said pivot shafts and disposed above and spaced apart from a corresponding one of said first positioning portions, and a guiding groove portion that is open in the left-to-right direction and that guides movement of the corresponding one of said pivot shafts into said engaging groove portion.

18. The object as claimed in claim 10, wherein the other of said first and second hook portions has a first contact inclined surface movable to contact said first guiding inclined surface, and a second contact inclined surface movable to contact said second guiding inclined surface.
